(19) United States
(12) Patent Application Publication
(10) Pub. No.: US 2024/0286903 A1
(43) Pub. Date: Aug. 29, 2024

(54) Crystalline Sp-Sp2 Hybridized Carbon Allotropes through Dynamic Covalent Synthesis

(71) Applicant: The Regents of the University of Colorado, a body corporate, Denver, CO (US)

(72) Inventors: Wei ZHANG, Boulder, CO (US); Yiming HU, Boulder, CO (US)

(21) Appl. No.: 18/585,791

(22) Filed: Feb. 23, 2024

Related U.S. Application Data
(60) Provisional application No. 63/486,907, filed on Feb. 24, 2023.

(51) Int. Cl. C01B 32/15

(52) U.S. Cl. CPC C01B 32/15; C01P 2002/20; C01P 2002/72; C01P 2002/84; C01P 2002/86; C01P 2002/88; C01P 2004/02; C01P 2004/04; C01P 2004/24; C01P 2006/12

(57) ABSTRACT

Disclosed is a method for the synthesis of crystalline [symbol] -graphyne which exhibits an ABC stacking pattern in the crystal structure. Alkyne metathesis is used to reversibly cleave and reform bonds between sp-hybridized carbon atoms to create an sp and sp²-hybridized carbon network. An exemplary method includes providing a first hexa-alkynyl substituted benzene co-monomer (e.g., HPB) and a second hexa-alkynyl substituted co-monomer (e.g., HHEB), and undergoing an alkyne metathesis reaction in the presence of a catalyst. During the reaction, small short chain alkyne byproducts can be removed, to drive the reaction toward the formation of the [symbol] -graphyne polymer product, while the larger alkyne byproducts can facilitate the self-correction process that will minimize the structural defects in the resulting [symbol] -graphyne.

### STATEMENT REGARDING FEDERALLY SPONSORED RESEARCH OR DEVELOPMENT

N/A.

### CROSS-REFERENCE TO RELATED APPLICATIONS

This application claims the benefit of and priority to U.S. Provisional Patent Application Ser. No. 63/486,907 filed on Feb. 24, 2023, and entitled “CRYSTALLINE SP-SP2 HYBRIDIZED CARBON ALLOTROPES THROUGH DYNAMIC COVALENT SYNTHESIS,” which application is expressly incorporated herein by reference in its entirety.

### BACKGROUND

As the research field of 2D materials continues to grow, so does the interest in carbon allotropes. Carbon allotropes have distinct physical properties arising from the unique combination and arrangement of carbon bonds. These carbon bonds may vary in length, strength, geometry, hybridization, and electron properties. Examples of well known carbon allotropes include graphite and diamond. Graphite is made from purely sp² hybridized carbon atoms and is opaque and soft. Diamond is made from purely sp³ hybridized carbon atoms and is transparent and is the hardest known natural material. Other examples of carbon allotropes include fullerene, carbon nanotubes, graphene, biphenylene, and cyclocarbon. Graphene, in particular, has gained wide interest due to its electron conducting properties.

While the above mentioned examples are all formed of a single type of hybridized carbon atoms, allotropes formed of a combination of hybridized carbon atoms exist and have been an active field of research. Graphynes are examples of a carbon allotrope formed of sp-hybridized carbon atoms periodically integrated into an sp²-hybridized carbon framework. It has been predicted that graphynes may exhibit unique electron conducting, mechanical, and optical properties. In particular, the electron conduction in graphynes could be as fast as in graphene. Additionally, it may be possible to control the electron conduction in some graphynes in a defined direction due to graphynes triple bonds which create distortion in Dirac cones compared to the multidirectional conduction found in graphene.

While a variety of low-molecular-weight graphyne fragments or ethynylene-linked molecular architectures have been synthesized, there is an ongoing need to synthesize more stable graphyne structures. Additionally, current synthesis techniques have occurred only on a small scale. Therefore, there is a need for bulk scale synthesis of graphyne families. Lastly, the lack of knowledge on the stacking order and orientation of adjacent graphyne layers has left a gap of knowledge in the field.

### BRIEF SUMMARY

Disclosed herein is a method for the synthesis of crystalline [symbol] -graphyne which exhibits an ABC stacking pattern in the crystal structure. Alkyne metathesis is used to reversibly cleave and reform bonds between sp-hybridized carbon atoms to create an sp and sp²-hybridized carbon network. Using the methods described herein can yield a [symbol] -graphyne product that exhibits a greater degree of polymerization.

An exemplary method for synthesizing [symbol] -graphyne involves providing a first hexa-alkynyl substituted benzene co-monomer and a second hexa-alkynyl substituted co-monomer. The method further involves undergoing an alkyne metathesis reaction in the presence of a catalyst wherein a product and a byproduct are produced. The method further involves removing a byproduct of the reaction to drive the reaction towards formation of the [symbol] -graphyne. The method optionally involves washing the product with a solvent to obtain the isolated [symbol] -graphyne.

In some embodiments, the method further involves activating the catalyst. In some embodiments, the catalyst comprises a Mo(IV) catalyst.

In some embodiments, the first hexa-alkynyl substituted benzene co-monomer is 1,2,3,4,5,6-hexapropynylbenzene (HPB) and the second hexa-alkynyl substituted benzene co-monomer is 1,2,3,4,5,6-hexakis[2-(4-hexylphenyl)ethynyl]benzene (HHEB). In some embodiments, the first hexa-alkynyl substituted benzene co-monomer and the second hexa-alkynyl substituted benzene co-monomer have a molar ratio of about 90% to about 10%.

In some embodiments, the byproduct is a short chain alkyne (e.g., 2-butyne and/or bis(4-hexylphenyl)acetylene).

The methods described herein are directed towards synthesizing [symbol] -graphyne, wherein the [symbol] -graphyne comprises alternating phenylene and alkynylene (e.g., ethynylene) components, where the alkynylene (e.g., ethynylene) components link adjacent phenylene components in an ordered, substantially 2D arrangement. In some embodiments the [symbol] -graphyne is in the form of a thin flake. In some embodiments, the [symbol] -graphyne is in the form of a thin flake layered film with steps of about 10 nm in thickness. In some embodiments, the [symbol] -graphyne thin flake includes about 1 to about 100 layers of [symbol] -graphyne stacked together.

In some embodiments, the [symbol] -graphyne produced has an ABC stacking crystal structure.

In some embodiments, the [symbol] -graphyne produced is substantially thermally stable and exhibits a weight loss of no more than about 8% at 250° C.

In some embodiments, the [symbol] -graphyne produced substantially maintains crystallinity after washing with one or more of acetone, DCM, THF, water, ammonium hydroxide, boiling water, 1M HCL, or 1M NaOH.

In some embodiments, the [symbol] -graphyne produced exhibits an electrical band gap of about 0.93 eV. In some embodiments, the [symbol] -graphyne produced exhibits a higher degree of polymerization when compared to [symbol] -graphyne produced by conventional methods.

Additional features and advantages will be set forth in part in the description that follows, and in part will be obvious from the description, or may be learned by practice of the embodiments disclosed herein. It is to be understood that both the foregoing brief summary and the following detailed description are exemplary and explanatory only and are not restrictive of the embodiments disclosed herein or as claimed.

### BRIEF DESCRIPTION OF THE DRAWINGS

To further clarify the above and other advantages and features of the present invention, a more particular description of the invention will be rendered by reference to specific embodiments thereof which are illustrated in the drawings located in the specification. It is appreciated that these drawings depict only typical embodiments of the invention and are therefore not to be considered limiting of its scope. The invention will be described and explained with additional specificity and detail through the use of the accompanying drawings.

FIG. 1 illustrates an example schematic of the structural relationship between graphene and graphyne.

FIG. 2 illustrates an example schematic of a cross-coupling reaction and an alkyne metathesis reaction.

FIG. 3 illustrates an example schematic of the synthesis of [symbol] -graphyne.

FIG. 4 illustrates an optical microscopy image of synthesized [symbol] -graphyne.

FIG. 5 illustrates NMR spectra of synthesized [symbol] -graphyne.

FIG. 6 illustrates thermal-gravimetric analysis of synthesized [symbol] -graphyne.

FIG. 7 illustrates an XRD pattern for a synthesized sample of [symbol] -graphyne after a sequential treatment with boiling water, 1M HCl and 1M NaOH, for 24 hours.

FIG. 8 illustrates a UV-Vis-NIR spectrum of synthesized [symbol] -graphyne.

FIG. 9 illustrates a Tauc plot of synthesized [symbol] -graphyne.

FIGS. 10 and 11 illustrate CV curves of synthesized [symbol] -graphyne.

FIG. 12 illustrates the WAXS pattern of synthesized [symbol] -graphyne.

FIG. 13 illustrates a lattice-resolution HRTEM image of synthesized [symbol] -graphyne.

FIG. 14 illustrates the SAED pattern of synthesized [symbol] -graphyne.

FIGS. 15A-15C illustrate an example crystal structure of synthesized [symbol] -graphyne.

FIGS. 16A-16C illustrate the folding behavior of synthesized [symbol] -graphyne.

### DETAILED DESCRIPTION OF THE PREFERRED EMBODIMENTS

### I. Definitions

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

The term “comprising” which is synonymous with “including,” “containing,” or “characterized by,” is inclusive or open-ended and does not exclude additional, unrecited elements or method steps.

The term “consisting essentially of” limits the scope of a claim to the specified materials or steps “and those that do not materially affect the basic and novel characteristic(s)” of the claimed invention.

The term “consisting of” as used herein, excludes any element, step, or ingredient not specified in the claim.

It must be noted that, as used in this specification and the appended claims, the singular forms “a,” “an” and “the” include plural referents unless the content clearly dictates otherwise. Thus, for example, reference to a “surfactant” includes one, two or more surfactants.

Unless otherwise stated, all percentages, ratios, parts, and amounts used and described herein are by weight.

Numbers, percentages, ratios, or other values stated herein may include that value, and also other values that are about or approximately the stated value, as would be appreciated by one of ordinary skill in the art. As such, all values herein are understood to be modified by the term “about”. Such values thus include an amount or state close to the stated amount or state that still performs a desired function or achieves a desired result. A stated value should therefore be interpreted broadly enough to encompass values that are at least close enough to the stated value to perform a desired function or achieve a desired result, and/or values that round to the stated value. The stated values include at least the variation to be expected in a typical manufacturing or other process, and may include values that are within 10%, within 5%, within 1%, etc. of a stated value.

Some ranges may be disclosed herein. Additional ranges may be defined between any values disclosed herein as being exemplary of a particular parameter. All such ranges are contemplated and within the scope of the present disclosure.

As used herein, the term “between” is inclusive of any endpoints noted relative to a described range.

In the application, effective amounts are generally those amounts listed as the ranges or levels of ingredients in the descriptions, which follow hereto. Unless otherwise stated, amounts listed in percentage (“%'s”) are in weight percent (based on 100% active) of any composition.

The phrase ‘free of’ or similar phrases if used herein means that the composition or article comprises 0% of the stated component, that is, the component has not been intentionally added. However, it will be appreciated that such components may incidentally form thereafter, under some circumstances, or such component may be incidentally present, e.g., as an incidental contaminant.

The phrase ‘substantially free of’ or similar phrases as used herein means that the composition or article preferably comprises 0% of the stated component, although it will be appreciated that very small concentrations may possibly be present, e.g., through incidental formation, contamination, or even by intentional addition. Such components may be present, if at all, in amounts of less than 1%, less than 0.5%, less than 0.25%, less than 0.1%, less than 0.05%, less than 0.01%, less than 0.005%, less than 0.001%, or less than 0.0001%. In some embodiments, the compositions or articles described herein may be free or substantially free from any specific components not mentioned within this specification.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

### II. General Overview of Example Synthesis

Disclosed embodiments form crystalline [symbol] -graphyne in solution phase through processes that are compatible with both small-scale and large-scale synthesis. Furthermore, [symbol] -graphyne is shown to have an ‘ABC’ stacking in the crystal structure. In general, embodiments use alkyne metathesis to reversibly cleave and then reform carbon bonds between sp-hybridized carbon atoms to obtain a crystalline [symbol] -graphyne network through a dynamic covalent synthetic approach.

Embodiments as described herein meticulously balance kinetics and thermodynamics of the reaction by simultaneously using two types of hexa-alkynyl substituted benzene components as co-monomers. This approach advantageously achieves error correction and polymer network growth with periodicity.

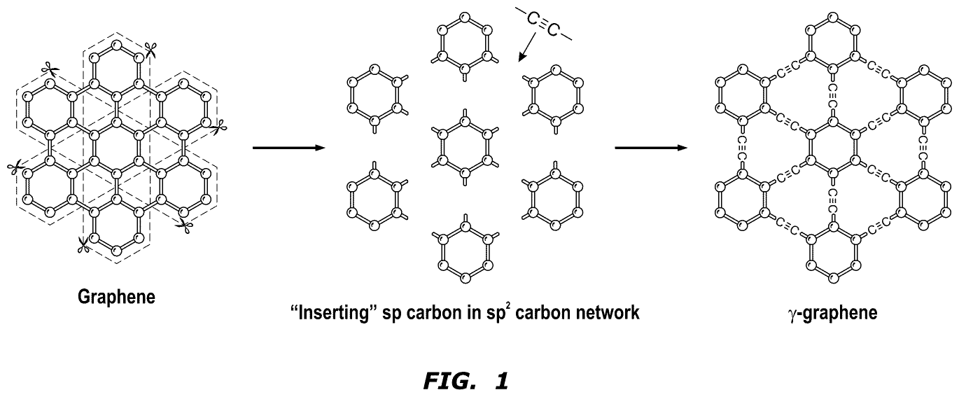

FIG. 1 illustrates the structural relationship between sp²-hybridized graphene and sp² and sp hybridized [symbol] -graphyne. As shown, the bonds linking the rings together in graphene can be cut and sp carbon atoms can be inserted into the carbon network. This results in the desired [symbol] -graphyne structure.

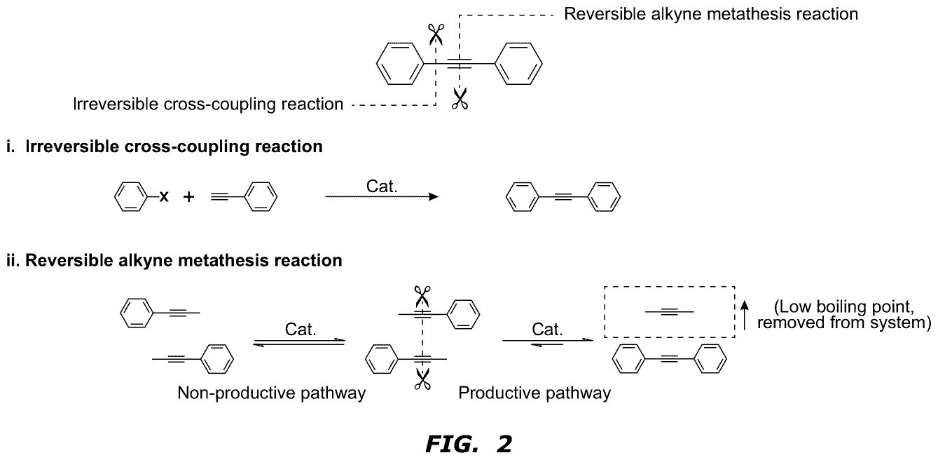

FIG. 2 illustrates an example of two possible routes for connecting the sp² and sp hybridized carbons. The first pathway is an irreversible cross-coupling reaction. The second pathway is a reversible alkyne metathesis reaction. The alkyne metathesis reaction redistributes the alkyne bonds by scission and reconnection. The alkyne metathesis reaction may proceed through a productive pathway or a non-productive pathway. In FIG. 2, phenylpropyne is used as the substrate in both pathways. In other embodiments, it may be possible to use other phenyl alkynes.

In the non-productive pathway, phenylpropyne is regenerated which results in no net change. In the productive pathway, diphenylacetylene and 2-butyne are formed. The volatile 2-butyne can then be removed to drive the reaction toward the formation of the polymer product, based on LeChâtelier's principle. While particular hexa-alkynyl substituted benzene constituents are illustrated, it will be appreciated that a variety of hexa-alkynyl constituents may be used within the process (e.g., having from 2-6, or 3-5 carbon atoms in the alkyne group).

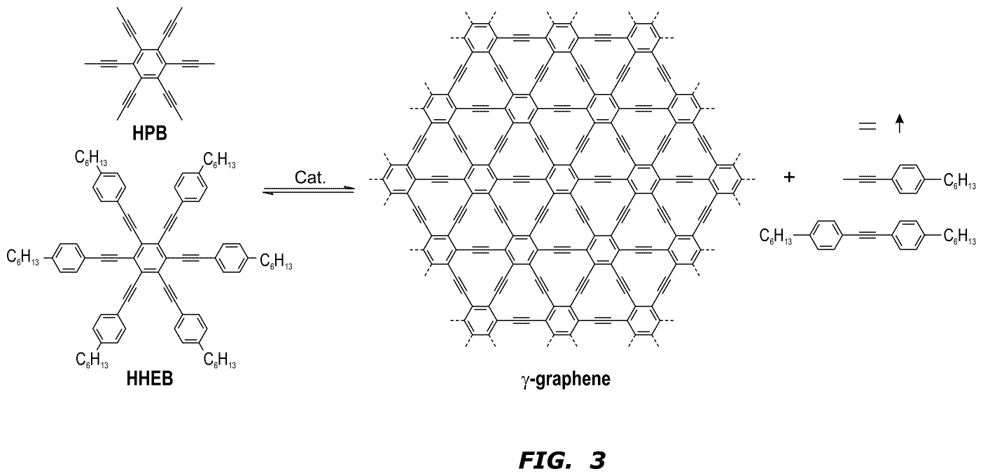

FIG. 3 illustrates an example of the synthesis of [symbol] -graphyne from 1,2,3,4,5,6-hexapropynylbenzene (HPB) and 1,2,3,4,5,6-hexakis[2-(4-hexylphenyl)ethynyl]benzene (HHEB). The reaction results in 2-butyne, 1-hexyl-4-(1-propyn-1-yl)-benzene and 2-bis(4-hexylphenyl)acetylene) as byproducts during polymerization. The reaction is driven forward towards polymerization by removing 2-butyne.

### III. Detailed Description of Exemplary Synthesis

Described embodiments advantageously utilize dynamic covalent reactions. Dynamic covalent reactions have shown success in constructing crystalline order polymeric architectures of single crystals of covalent organic frameworks and helical covalent polymers with long range order. Dynamic covalent reactions enable error correction under thermodynamic control and achieve structural order in the resulting polymer networks. As illustrated in FIG. 2, there are two illustrated pathways to construct sp and sp² hybridized carbon bonds. Various other mechanisms and pathways using the principles described herein may also be apparent to those of skill in the art.

The first illustrated pathway involves formation of carbon-carbon single bonds between phenylene and ethynylene groups. The cross-coupling between the sp-hybridized carbon atoms and the sp²-hybridized carbon atoms is an irreversible reaction. This synthetic pathway generally fails to provide bulk polymeric materials with low defect densities. As such, this pathway is not preferred.

Preferred embodiments form carbon-carbon triple bonds through an alkyne metathesis reaction which is a reversible reaction. The alkyne metathesis reaction can proceed through a non-productive or productive pathway. In the non-productive pathway, end groups are simply exchanged without forming new chemical structures. In the productive pathway, new products are formed along with small short chain (e.g., C2-C6) alkyne byproducts (e.g., 2-butyne). Because the productive pathway is reversible, this advantageously enables both polymer growth and self-correction. As a result, the productive pathway is the preferred pathway in at least some embodiments.

Embodiments according to the present invention use alkyne metathesis as the suitable dynamic covalent reaction to polymerize hexa-alkynyl benzene monomers and form [symbol] -graphyne with high crystallinity. In some embodiments, the non-productive pathway can be suppressed and polymerization promoted by removing the short chain alkyne byproduct (e.g., 2-butyne). By removing 2-butyne, the equilibrium is driven towards polymer growth.

Embodiments as described herein rely on small, short chain alkyne byproducts for error correction. The small short chain alkyne byproducts have better mobility compared to the alkyne groups embedded in the polymer network and therefore have a greater chance of reversibly reacting with triple bonds on defect sites and repositioning the atoms into the correct or desired placement as shown in the Figures.

In some embodiments, the major monomer for [symbol] -graphyne synthesis was HPB. In the illustrated embodiment, the HPB is an example of a hexa-alkynyl substituted benzene derivative that includes propynyl groups attached at each of the 6 positions of the benzene ring. It will be appreciated that in other embodiments, alkynyl groups of various desired length may alternatively or additionally be used (e.g., C2-C6, or C3-C5). Alkyne synthesis of HPB produces 2-butyne as the byproduct in the productive pathway. 2-butyne has a low boiling point, which allows 2-butyne to be removed easily under reduced pressure, thereby promoting the desired polymer growth. However, if the polymerization is fully driven by kinetic growth, the desired ordered structure is challenging to obtain, since kinetically trapped amorphous solids with undesired and disordered bond connections will be predominantly formed.

Preferred embodiments facilitate self-correction during the polymer growth by adding HHEB or an analogous hexa-alkynyl substituted benzene component as a co-monomer. Such analogous alternative phenyl components may include benzene groups, with alkynyl groups bonded to each of the 6 ring positions, each also bonded to another benzene group as shown. While the illustrated HHEB component includes ethynyl groups linking the benzene rings, it will be appreciated that other (e.g., longer alkynyl groups) could alternatively be used as the linking component. As shown in FIG. 3, HHEB has the same or similar repeating monomer unit as HPB but instead of propynyl, HHEB has hexyl-substituted phenylethynyl at the end group.

Disclosed embodiments take advantage of the following benefits of HHEB monomers. First, hexyl substituents substantially increase the solubility of graphyne oligomers. This allows embodiments to grow larger ordered domains before precipitating an initial nucleus. Secondly, unlike 2-butyne, the byproduct bis(4-hexylphenyl)acetylene has comparable reactivity as the graphyne repeating unit. Additionally, bis(4-hexylphenyl)acetylene has a lower kinetic barrier which allows it to reversibly react with the graphyne fragment. This results in embodiments being able to correct undesired bond formations with kinetically introduced disorder. Thirdly, HHEB has a backbone structure that mimics the repeating unit of [symbol] -graphyne. This provides embodiments with a templating effect for [symbol] -graphyne growth. In general, embodiments use HHEB as a correction modulator by increasing the reversibility of alkyne metathesis and promoting self-correction. Use of HHEB and HPB as described may be particularly beneficial.

In embodiments, the ratio between the two co-monomers, HPB and HHEB, is important, perhaps even critical. When HPB is the sole monomer, an amorphous solid is obtained. When excess HHEB is used, the polymer growth is inhibited and only soluble short oligomers are formed due to the predominant non-productive pathway. In some embodiments the mixture includes from 0% to 100% of HPB and 0% to 100% of HHEB, although preferably, some of each component is preferably present. For example, in some embodiments, the mixture of the two components contains about 70% HPB and about 30% HHEB, or about 80% HPB and about 20% HHEB, or about 90% HPB and about 10% HHEB, or about 95% HPB and about 5% HHEB. Such amounts are molar percentages. HPB (or an analog thereof) may be present in a range of from about 50% to about 95%, from about 60% to about 95%, from about 70% to about 95%, or from about 75% to about 95% by molar fraction of the mixture of the two components. HHEB (or an analog thereof) may be present in a range of from about 5% to about 40%, from about 5% to about 30%, from about 5% to about 25%, or from about 5% to about 20% by molar fraction of the mixture of the two components.

A particularly desirable ratio was found at about 90% HPB and about 10% HHEB. The HPB provides the driving force for polymerization and crystalline domain growth, while the HHEB promotes self-correction and formation of the ordered framework structure. In some embodiments, a Mo(VI) alkyne metathesis catalyst is used. The Mo(VI) alkyne metathesis catalyst has high stability, a long life time, and a high catalytic efficiency. It will be appreciated that other catalysts providing desired properties may additionally or alternatively be used.

IV. Example Synthesis of [symbol] -graphyne

The small-scale synthesis of [symbol] -graphyne began with an argon-filled glovebox where a 10 mL Schlenk tube was charged with HPB (22.0 mg, 0.072 mmol) and HHEB (8.6 mg, 0.008 mmol). This was followed by the addition of 1 mL CCl₄ solution/suspension of activated catalyst (0.005 mmol) and 2 mL fresh CCl₄.

The catalyst was activated in an Argon-filled glovebox. A 1-dram vial was charged with the precursor (3.2 mg. 0.005 mmol) and the ligand (0.005 mmol). Next, 1 mL dry CCl₄ was added, and the mixture was heated at 70° C. for 30 min to obtain the activated catalyst.

Next, the tube was sealed and taken out from the glovebox and all the contents were frozen in a liquid nitrogen bath until no liquid was observed. The headspace was evacuated through Schlenk line until the pressure was lower than 100 mTorr.

The tube was heated in a 70° C. oil bath without disturbance. After 1, 3, 5, 8, 12, and 24 h, the tube was cooled in a liquid nitrogen bath until the CCl₄ froze and then evacuated to remove the 2-butyne byproduct for 1 min. All the contents were frozen in a liquid nitrogen bath until no liquid was observed, and the headspace was evacuated through Schlenk line until the pressure was lower than 100 mTorr. The tube was put back to the same oil bath. After 3 days, a dark black solid formed on the wall of the tube. The solid was collected via centrifugation, and washed with THF (10 mL×3), MeOH/NH₄OH (4/1, v/v, 10 mL×3), and acetone (10 mL×3) consequently to provide [symbol] -graphyne (6.3 mg, 72%). Washing aids in removing small molecule residues, including catalyst particles, that may remain.

For the large-scale synthesis of [symbol] -graphyne, the key factors affecting the reaction are the efficient removal of the byproduct and maintaining the reactivity of the catalyst.

The large-scale synthesis of [symbol] -graphyne begins in an Argon-filled glovebox. A 50 mL Schlenk flask was charged with HPB (110.0 mg, 0.36 mmol) and HHEB (43 mg, 0.04 mmol), followed by the addition of 5 mL CCl₄ solution/suspension of activated catalyst (0.025 mmol) and 10 mL fresh CCl₄.

The catalyst was activated in an Argon-filled glovebox. A 1-dram vial was charged with the precursor (3.2 mg. 0.005 mmol) and the ligand (0.005 mmol). Next, 1 mL dry CCl₄ was added, and the mixture was heated at 70° C. for 30 min to obtain the activated catalyst.

The flask was sealed and taken out from the glovebox. All the contents were frozen in a liquid nitrogen bath until no liquid was observed, and the headspace was evacuated through Schlenk line until the pressure lower than 100 mTorr. The flask was heated in a 70° C. oil bath without disturbance. After 1, 3, 5, 8, 12, and 24 h, the flask was cooled in a liquid nitrogen bath until the CCl₄ froze. The flask was then evacuated to remove the 2-butyne byproduct with vigorous shaking for 1 min. All the contents were frozen in a liquid nitrogen bath until no liquid was observed, and the headspace was evacuated through Schlenk line until the pressure was lower than 100 mTorr. The flask was put back into the same oil bath. After 24 h, another 5 mL CCl₄ solution/suspension of activated catalyst (0.025 mmol) was added. After another 2 days, a dark black solid formed on the wall of the flask. The solid was collected via centrifugation and washed with THF (50 mL×3), MeOH/NH₄OH (4/1, v/v, 50 mL×3), and acetone (50 mL×3) consequently to provide [symbol] -graphyne.

### V. Experimental Structural Characterization

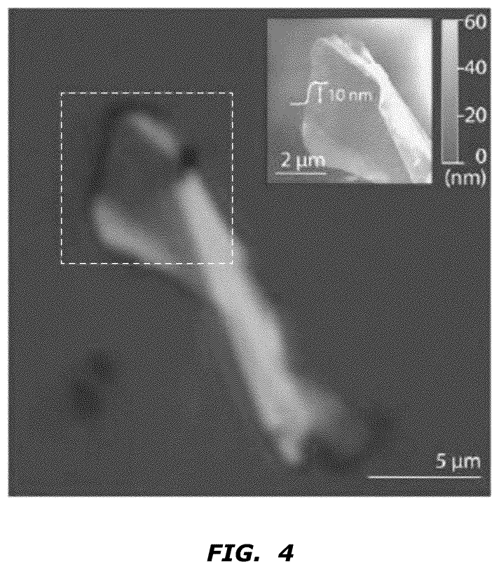

FIG. 4 illustrates results from optical microscopy of the synthesized [symbol] -graphyne and corresponding atomic force microscopy (AFM) image. A dispersion of graphyne thin films in acetone was transferred to isopropyl alcohol, sonicated, and drop casted onto 100 nm SiO₂/Si wafer. The dark reflection of the optical microscopy illustrates a large-area thin layered film. The AFM image confirms the layered film with steps around 10 nm, corresponding to about 30 layers of [symbol] -graphyne stacked together. Additionally, the free-standing flake had an area of over 10 μm² resulting in a bulk low-dimensional [symbol] -graphyne material.

Next, the precipitate obtained from the [symbol] -graphyne synthesis as described herein (i.e., alkyne metathesis reaction) was washed with tetrahydrofuran (THF) and ammonium hydroxide solution to remove the molybdenum based catalyst residue. X-ray photoelectron spectroscopy (XPS) confirmed that substantially all of the molybdenum species were removed after washing.

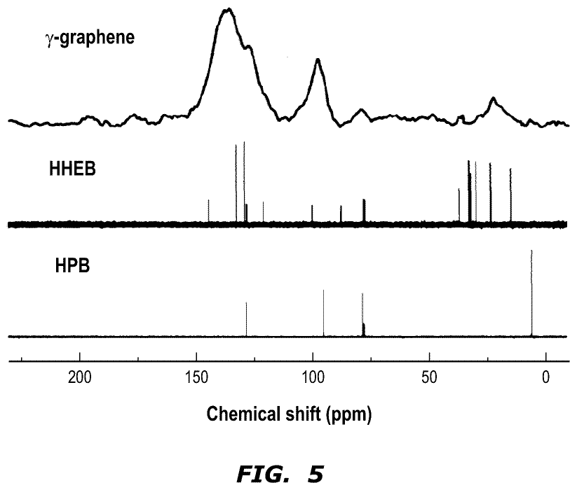

Magic-angle spinning (MAS) solid-state nuclear magnetic resonance (NMR) characterization supported the conclusion of the formation of [symbol] -graphyne via the example synthesis described. The MAS solid-state NMR results are illustrated in FIG. 5, wherein the resonance signals at 140 ppm correspond to the aromatic carbons in synthesized [symbol] -graphyne, and the resonance signals 100 ppm correspond to the alkyne carbons in synthesized [symbol] -graphyne. The relatively small peaks at 20 ppm and 75 ppm are from the residual hexylphenylacetylene end groups.

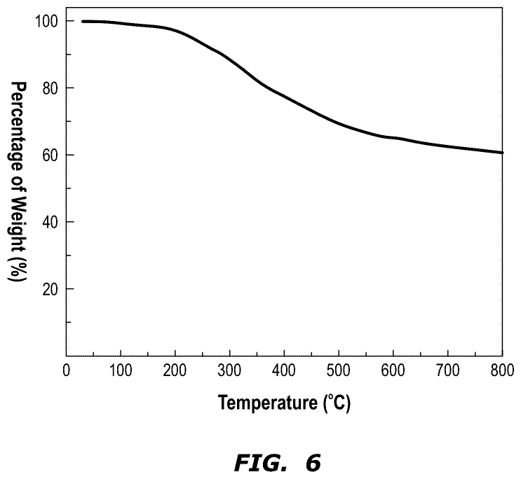

Thermogravimetric analysis was also performed, and the results are shown in FIG. 6, wherein [symbol] -graphyne is shown to be thermally stable up to 250° C. with 8% weight loss.

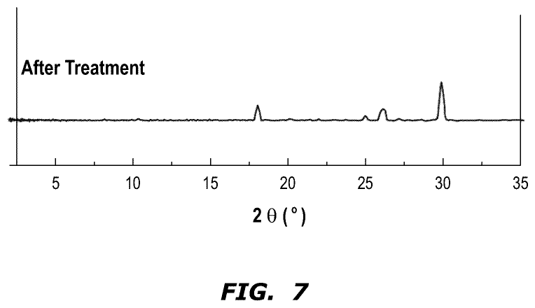

XRD analysis additionally confirmed that the [symbol] -graphyne had crystallinity after washing with a variety of solvents (e.g., acetone, DCM, THF, water, and ammonium hydroxide solutions). After sequentially soaking in boiling water, 1M HCl and 1M NaOH for 24 hours, the [symbol] -graphyne did not show any significant decrease in crystallinity. The results are shown in FIG. 7, which confirm the stability of the formed [symbol] -graphyne.

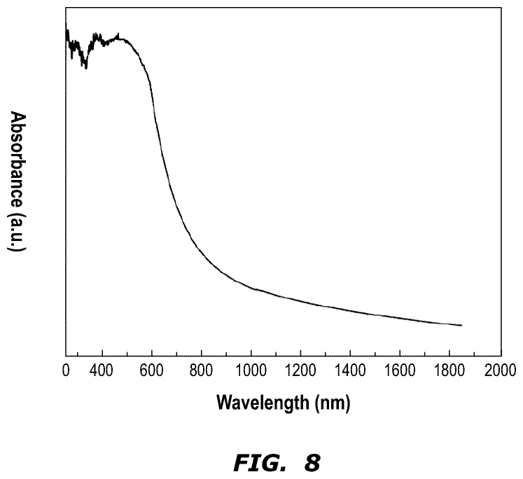

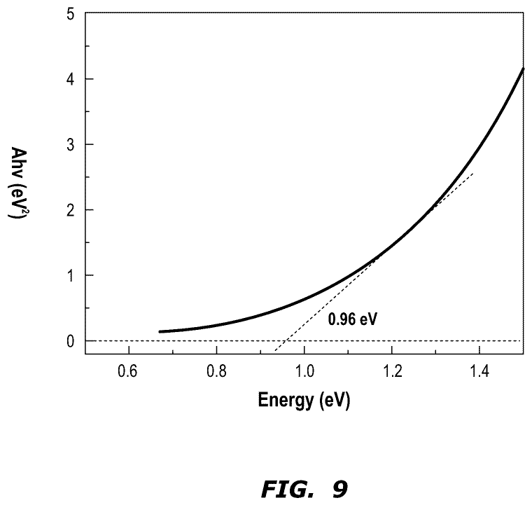

Solid-state UV-Vis-NIR spectroscopy was performed to estimate the band gap of the formed [symbol] -graphyne. The results are illustrated in FIG. 8, where [symbol] -graphyne shows a broad absorption in UV, visible, and near IR range. Using the Tauc method, an optical band gap was determined to be 0.96 eV, as shown in FIG. 9.

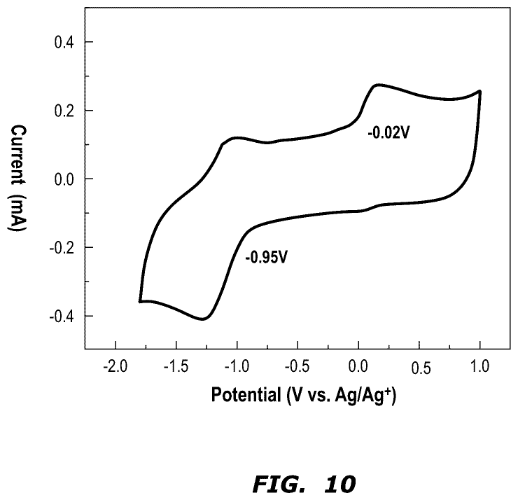

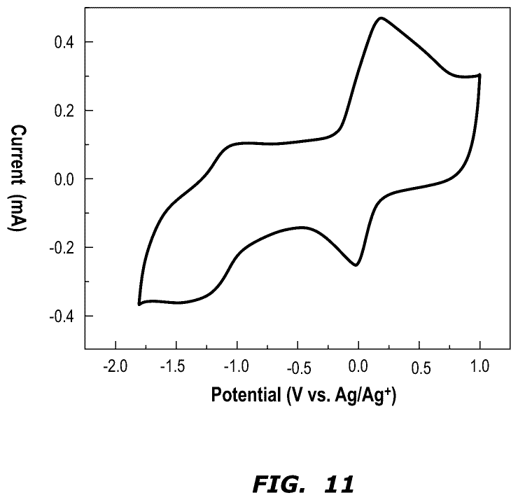

Cyclic voltammetry was performed on the [symbol] -graphyne. The results are illustrated in FIGS. 10 and 11. Results showed a reduction potential of −0.95 V vs. Ag/Ag⁺ and an oxidation potential of −0.02 V vs. Ag/Ag⁺ with an electronic band gap of 0.93 eV. It should be noted that this band gap value is approximately three times lower than the typical band gap values reported for [symbol] -graphyne synthesized via coupling reactions (i.e., about 2.7 eV). It is well known within the art that relatively lower band gap values in polymers correspond to relatively higher degrees of polymerization. Therefore, the reported band gap value (i.e., 0.93 eV) for the [symbol] -graphyne synthesized via alkyne metathesis as described herein demonstrates that the [symbol] -graphyne comprises an improved degree of polymerization compared to the products obtained via typical methods of [symbol] -graphyne synthesis. The [symbol] -graphyne synthesized as described herein displayed a semiconductor band structure where the highest occupied molecular orbital (HOMO) energy was −4.78 eV and the lowest unoccupied molecular orbital (LUMO) energy was −3.85 eV. These results are shown in FIGS. 10 and 11 respectively where ferrocene was the internal reference.

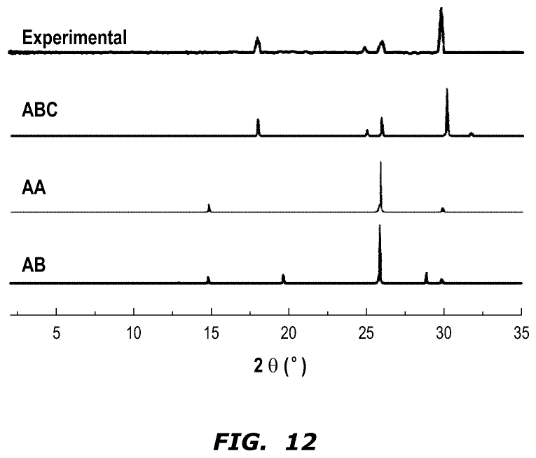

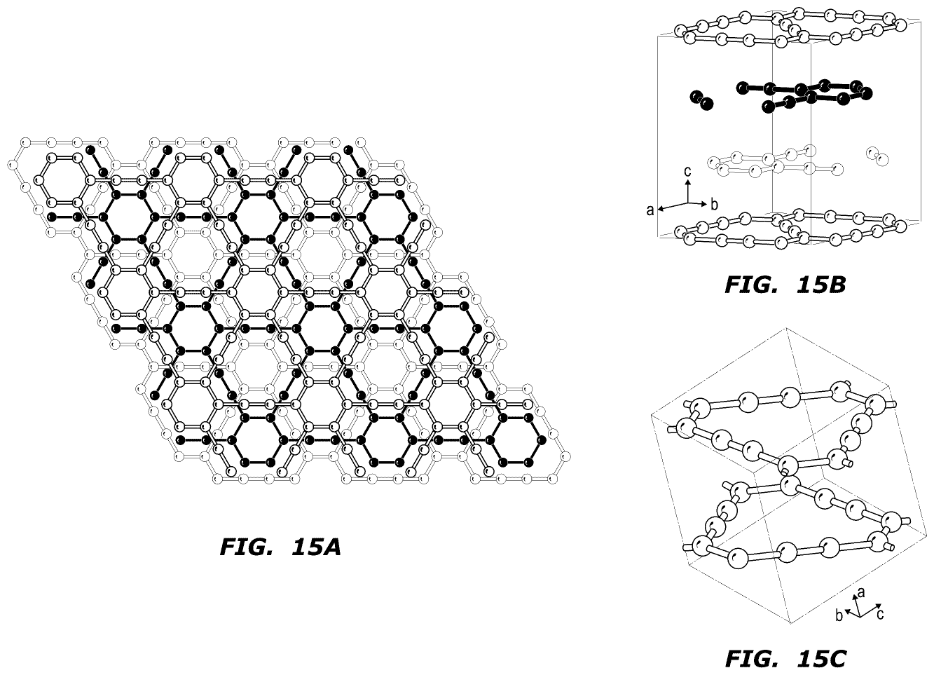

Wide angle X-ray scattering (WAXS) characterization of the obtained [symbol] -graphyne showed a unified crystalline structure. Results are shown in FIG. 12, which shows the WAXS pattern of bulk [symbol] -graphyne (top line) and calculated profiles of the simulated ABC stacking model (further illustrated in FIGS. 15A-15C) (3^{rd} line), AA stacking model (2^{nd} line), and AB stacking model (bottom line). The results shown in FIG. 12 indicate the ABC stacking model substantially matches the experimental model with diffraction peaks at 2θ=18.01°, 24.95°, 26.09°, and 29.87°. The lattice constant of the 2D lattice was estimated to be 0.69 nm through plane-wave density functional theory (DFT) calculations.

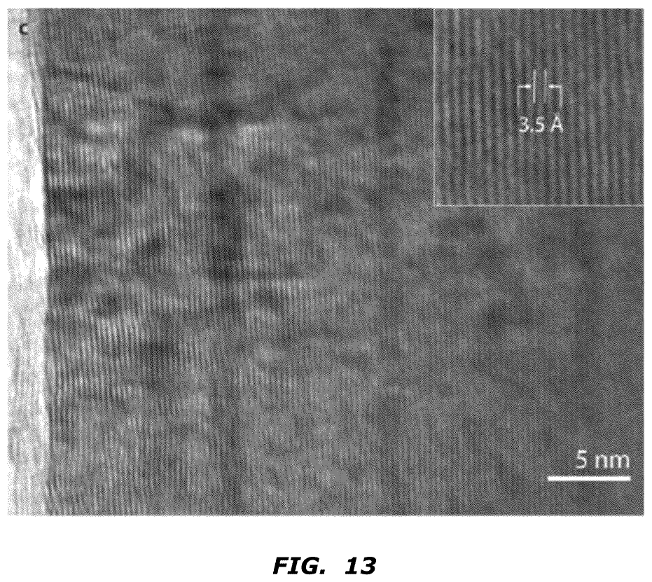

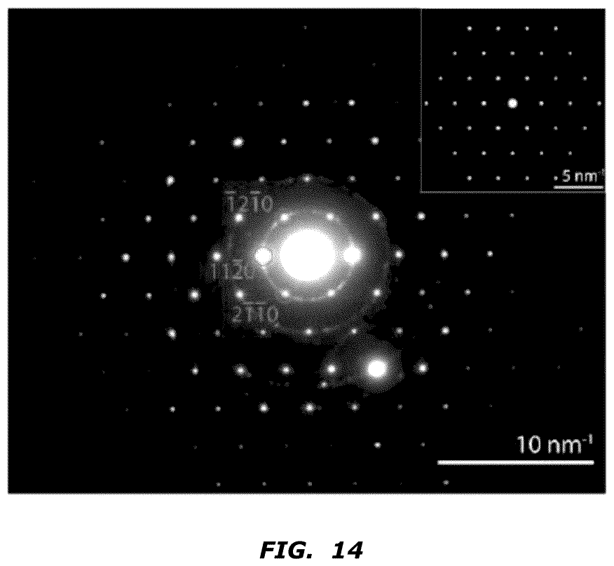

FIG. 13 shows a lattice-resolution high-resolution transmission electron microscopy (HRTEM) image of [symbol] -graphyne showing consistent lattice fringes which are aligned vertically and parallel with 0.35 nm spacing. FIG. 14 shows the selected area electron diffraction (SAED) pattern of the [symbol] -graphyne wherein the [symbol] -graphyne has a maximum plane spacing of 0.35 nm, and wherein [symbol] -graphyne displays a hexagonal reciprocal lattice, indicating the existence of C₆ symmetry. Miller indices of representative crystal planes in accordance with the hexagonal representations of the ABC stacking model are also shown in FIG. 14.

FIGS. 15A-15C illustrate the crystal structure of [symbol] -graphyne (FIG. 15A) with the unit cell (FIG. 15B) and primitive cell (FIG. 15C) showing an ABC stacking. The ABC stacking model of [symbol] -graphyne is a #166 R-3M space group in a hexagonal lattice. The space group can be simplified via a rhombohedral representation shown in the primitive cell. The primitive cell indicates an intrinsic bilayer stacking nature within the ABC stacking mode.

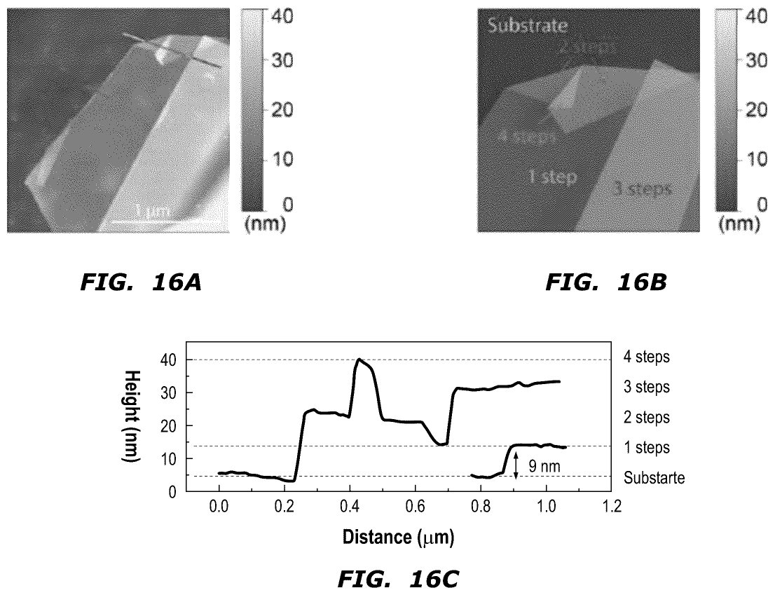

FIGS. 16A-16C illustrate the folding behavior of [symbol] -graphyne with the AFM image (FIG. 16A) and an illustration (FIG. 16B). The exfoliated films exhibit layered height profiles seen as step-edges within a single flake with a height of 9 nm. FIG. 16C shows the height plot of the layered structure of exfoliated [symbol] -graphyne.

Without departing from the spirit and scope of this invention, one of ordinary skill can make various modifications to the invention to adapt it to various usages and conditions. As such, these changes and modifications are properly, equitably, and intended to be, within the full range of equivalence of the following claims.

1. A method for synthesizing [symbol] -graphyne comprising:
providing a first hexa-alkynyl substituted benzene co-monomer and a second hexa-alkynyl substituted co-monomer;
undergoing an alkyne metathesis reaction in the presence of a catalyst wherein a product and a byproduct are produced; and
removing the byproduct of the reaction to drive the reaction towards formation of the [symbol] -graphyne;
optionally washing the product with a solvent to obtain the [symbol] -graphyne.

2. The method of claim 1, wherein the [symbol] -graphyne has an ABC stacking crystal structure.

3. The method of claim 1, wherein the first hexa-alkynyl substituted benzene co-monomer comprises 1,2,3,4,5,6-hexapropynylbenzene.

4. The method of claim 1, wherein the second hexa-alkynyl substituted benzene co-monomer comprises 1,2,3,4,5,6-hexakis[2-(4-hexylphenyl)ethynyl]benzene.

5. The method of claim 1, further comprising activating the catalyst.

6. The method of claim 1, wherein the catalyst comprises a Mo(VI) catalyst.

7. The method of claim 1, wherein the first hexa-alkynyl substituted benzene co-monomer and the second hexa-alkynyl substituted benzene co-monomer have a molar ratio of about 90% to about 10%.

8. The method of claim 1, wherein the solvent comprises at least one of THE, methanol, ammonium hydroxide, or acetone.

9. The method of claim 1, wherein the alkyne metathesis reaction proceeds through a productive pathway that produces the byproduct.

10. The method of claim 1, wherein the byproduct comprises 2-butyne.

11. The method of claim 1, wherein the byproduct comprises a short chain alkyne.

12. Synthesized [symbol] -graphyne comprising:
alternating phenylene and alkynylene (e.g., ethynylene) components, where the alkynylene (e.g., ethynylene) components link adjacent phenylene components in an ordered, substantially 2D arrangement.

13. The [symbol] -graphyne of claim 12, wherein the [symbol] -graphyne is in the form of a thin flake.

14. The [symbol] -graphyne of claim 12, wherein the [symbol] -graphyne is in the form of a thin flake layered film with steps of about 10 nm in thickness.

15. The [symbol] -graphyne of claim 13, wherein the [symbol] -graphyne thin flake includes about 1 to about 100 layers of [symbol] -graphyne stacked together.

16. The [symbol] -graphyne of claim 13, wherein the [symbol] -graphyne is in the form of a thin flake that includes about 30 layers of [symbol] -graphyne stacked together.

17. The [symbol] -graphyne of claim 13, wherein the [symbol] -graphyne is in the form of a thin flake that has a surface area of greater than about 10 μm².

18. The [symbol] -graphyne of claim 12, wherein the [symbol] -graphyne is substantially thermally stable, exhibiting a weight loss of no more than about 8% at 250° C.

19. The [symbol] -graphyne of claim 12, wherein the [symbol] -graphyne substantially maintains its crystallinity after washing with one or more of acetone, DCM, THF, water, ammonium hydroxide, boiling water, 1M HCl, or 1M NaOH.

20. The [symbol] -graphyne of claim 12, wherein the [symbol] -graphyne exhibits an electrical band gap of about 0.93 eV and/or an optical band gap of about 0.96 eV.
